(19) United States
(12) Patent Application Publication
(10) Pub. No.: US 2025/0258484 A1
(43) Pub. Date: Aug. 14, 2025

(54) A STRUCTURE OF PLASTIC PARTICLE PROCESSING SYSTEM

(71) Applicant: Motan Holding GmbH, Konstanz (DE)

(72) Inventor: Ziyi Wang, Suzhou (CN)

(73) Assignee: Motan Holding GmbH, Konstanz (DE)

(21) Appl. No.: 18/856,323

(22) PCT Filed: Apr. 12, 2023
(86) PCT No.: PCT/EP2023/059590

§ 371 Date: Oct. 11, 2024

(30) Foreign Application Priority Data
Apr. 14, 2022 (CN) 202210391636.8

(51) Int. Cl. G05B 19/418

(52) U.S. Cl. CPC G05B 19/41855; G05B 2219/31145

(57) ABSTRACT

A plastic particle processing system structure is based on Ethernet communication. It includes a main controller, drying air generator mechanism, drying bin mechanism, secondary conveying mechanism and blender mechanism. The main controller communicates with drying air generator mechanism, drying bin mechanism, secondary conveying mechanism and blender mechanism through Ethernet. The input and output devices in the drying bin mechanism and the blender mechanism are installed with intelligent distributed controllers, and the input and output devices in the secondary conveying mechanism are installed with distributed nodes; The present invention proposes a plastic particle processing system structure based on Ethernet communication. The raw material processing system in the production process of plastic products is managed by the same main control system, and all links can be connected with each other to achieve unified management and control of the system and improve production efficiency.

### CROSS-REFERENCE TO RELATED APPLICATION

This application is a national stage application, filed under 35 U.S.C. § 371, of International Patent Application PCT/EP2023/059590, filed on Apr. 12, 2023, which claims the benefit of Chinese Patent Application CN 202210391636.8, filed on Apr. 14, 2022.

### TECHNICAL FIELD

The disclosure belongs to the technical field of plastic product production control, in particular to a plastic particle processing system structure based on Ethernet communication.

### BACKGROUND

In the field of plastic particle raw material processing, it generally includes the drying, conveying and dosing and mixing of raw materials. The drying system usually includes drying air generator, drying bin and other equipment. The conveying system usually includes hopper loader, vacuum pump, filter and other equipment. The dosing and mixing system is usually a stand-alone blender, which is a volume or weight type. Generally, these equipment are independent of each other and have independent control systems. The operation status and data of each equipment cannot be known from each other. However, according to the current development situation, many times these different process equipment are obviously related. The material supply of the drying system is completed by the conveying system, and the material consumption of the drying bin is calculated by the volume of the hopper loader and the suction frequency. The real-time material consumption of the drying bin is closely related to the drying control of the drying bin. The material supply of the blender is also completed by the conveying system. The blender often needs to switch the material recipe, and the materials used also need to change automatically. This requires changing the material source setting of the suction in the conveying system. When there are regrind materials in the injection molding process, it is necessary to recycle the regrind materials and mix them with new raw materials in a certain proportion before drying. Usually, the factory will install the blender on the drying bin, set a certain proportion in the blender, and put the mixed materials into the drying bin. However, different material proportions (different recipes) have different requirements for the feeding process. At present, the production and manufacturing of plastic products are becoming more and more large-scale, systematic and intelligent, which requires more and more systematic raw material processing systems. If the unified management between independent process equipment cannot be achieved, the efficiency of plant operation will be greatly affected.

It should be noted that the above content belongs to the technical cognition of the inventor and does not necessarily constitute the existing technology.

### SUMMARY

In order to solve the above problems, the purpose of the disclosure is to provide a plastic particle processing system structure that can coordinate and link all links of the raw material processing system.

To achieve the above purpose, the disclosure proposes a plastic particle processing system structure based on Ethernet communication, which is characterized in that the drying air generator mechanism, the drying bin mechanism, the secondary conveying mechanism and the blender mechanism are connected to a main controller. The main controller communicates with the drying air generator mechanism, the drying bin mechanism, the conveying mechanism and the blender mechanism through Ethernet. The drying air generator mechanism, the drying bin mechanism and the dosing and mixing machine mechanism preferably are all equipped with intelligent distributed controllers to control the input and output devices. The secondary conveying mechanism is preferably controlled by distributed nodes. All intelligent distributed controllers and distributed nodes are connected to the same network through Ethernet, and IP addresses and device names are assigned. The main controller performs unified management and control.

In one example, the number, specification and model of the drying air generator mechanism, the drying bin mechanism and the blender mechanism are set in the main controller. According to the application requirements, parameters and recipe information are set for the independent operating equipment that can be operated by the intelligent distributed controller.

In one example, the intelligent distributed controller is controlled as both the control unit of the local mechanism and the distributed IO node of the main controller.

In one example, the intelligent distributed controller is installed with independent logic control program and can operate independently. The setting of operation parameters is given by the main control system.

In one example, the drying air generator mechanism comprises a drying air module, an air volume increase module and a low dew point module.

In one example, the drying bin mechanism comprises a drying bin unit and a blender, and the drying bin unit comprises a drying bin, a loader and a purging valve.

In one example, the secondary conveying mechanism includes a loader, a purging valve, a vacuum pump and a filter.

The plastic particle processing system structure based on Ethernet communication can bring the following beneficial effects:
1. The raw material handling system in the production process of plastic products is managed by the same main control system, and all links can be connected to each other, realizing the unified management and control of the system, and improving the production efficiency.
2. Each distributed controller in the system has an independent logic control function, which can operate independently. The setting of operation parameters is given by the main control system. On the basis of improving the reliability of the continuous operation of the system, it also increases the correlation between the equipment in the system.
3. The control of the primary conveying part is indirectly controlled by the controller of the drying bin, which can make the drying bin clearly know the operation of the loader, facilitate the calculation of the material consumption, and adjust the drying conditions in real time, so as to reduce the energy consumption on the premise of meeting the drying effect. In addition, the number of signal cable laying and installation time of the primary conveying related equipment can also be significantly reduced, saving the investment cost.
4. The system manages the information of all blenders and automatically links with other relevant equipment. When the recipe of the blender changes, it can automatically adjust the drying parameters of the drying bin and the material source of the hopper loader on the blender, which reduces the workload of daily operation and greatly reduces the error rate of operation, thus improving the production efficiency of the plant.
5. All controllers and distributed nodes are connected by Ethernet. With the current network connection technology, the system deployment and structure expansion can be easily completed.

### BRIEF DESCRIPTION OF THE DRAWINGS

The drawings described here are used to provide a further understanding of the invention. The schematic embodiments and descriptions of the invention are used to explain the invention and do not constitute an improper limitation of the invention. In the attached figures:

FIG. 1 is the structural schematic diagram of a plastic particle processing system structure based on Ethernet communication.

FIG. 2 is the schematic diagram of the combination of drying system and primary feeding conveying system.

FIG. 2.1 is another embodiment of the combination of drying system and primary feeding conveying system.

FIG. 3 is the schematic diagram of the combination of the dosing and mixing system and the secondary feeding conveying system.

FIG. 3.1 is another embodiment of the combination of the dosing and mixing system and the secondary feeding conveying system.

FIG. 4 shows the combination of dosing & mixing system and drying system.

FIG. 4.1 shows the combination of dosing and mixing system and drying system.

### DETAILED DESCRIPTION

In order to more clearly explain the overall concept of the invention, the following is a detailed description in the form of examples in combination with the drawings of the specification.

In the description of the invention, it is necessary to understand that the orientation or position relationship indicated by the terms “center”, “up”, “down”, “front”, “back”, “left”, “right”, “vertical”, “horizontal”, “top”, “bottom”, “inside”, “outside”, “axial”, “radial”, “circumferential”, etc. is based on the orientation or position relationship shown in the attached drawings, and is only for the convenience of describing the invention and simplifying the description, Rather than indicating or implying that the device or element referred to must have a specific orientation, be constructed and operated in a specific orientation, it cannot be understood as a limitation of the present invention.

In addition, the terms “first” and “second” are only used for describing purposes, and cannot be understood as indicating or implying relative importance or implying the number of technical features indicated. Therefore, the features defined as “first” and “second” can explicitly or implicitly include one or more of these features. In the description of the present invention, “multiple” means two or more, unless otherwise specifically defined.

In the present invention, unless otherwise specified and limited, the terms “installation”, “connection”, “connection”, “fixation” and other terms should be understood in a broad sense, for example, they can be fixed connection, removable connection, or integrated; it can be mechanical connection, electrical connection or communication; it can be directly connected, or indirectly connected through intermediate media, or it can be the internal connection of two components or the interaction between two components. For those skilled in the art, the specific meaning of the above terms in the invention can be understood according to the specific situation.

In the present invention, unless otherwise clearly defined and defined, the first feature can be directly contacted by the first and second features in the second feature “up” or “down”, or the first and second features can be indirectly contacted through intermediate media. In the description of this specification, the description referring to the terms “one scheme”, “some schemes”, “examples”, “specific examples”, or “some examples” means that the specific features, structures, materials or features described in combination with the scheme or examples are included in at least one scheme or example of the invention. In this specification, the schematic expression of the above terms does not have to refer to the same scheme or example. Moreover, the specific features, structures, materials or features described can be combined in an appropriate way in any one or more schemes or examples.

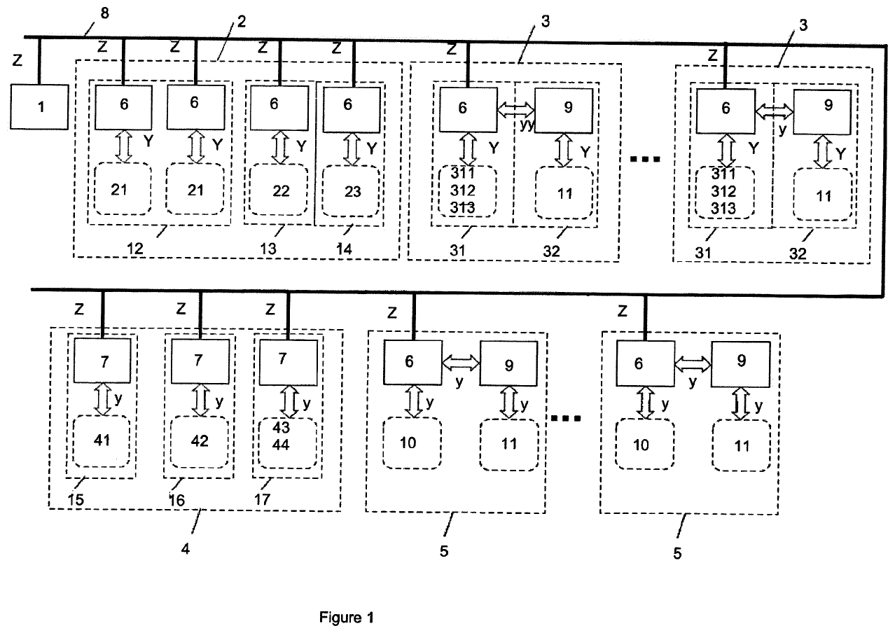

As shown in FIG. 1, the embodiment of the invention proposes a plastic particle processing system structure based on Ethernet communication, which includes at least one main controller 1, drying air generator mechanism 2, drying bin mechanism 3, secondary conveying mechanism 4 and blender mechanism 5. The main controller 1 communicates with drying air generator mechanism 2, drying bin mechanism 3, secondary conveying mechanism 4 and blender mechanism 5 through Ethernet. The intelligent distributed controller 6 is installed in the drying bin mechanism 3 and the blender mechanism 5. The input and output devices in the secondary conveying mechanism 4 are controlled by the distributed node 7. All the intelligent distributed controllers 6 and distributed nodes 7 are connected to the same network specifically through Ethernet 8. The IP address and device name are assigned. The main controller 1 is responsible for unified management and control.

Specifically, the number, specification and model of drying air generator mechanism 2, drying bin mechanism 3 and blender mechanism 5 are set in the main controller 1. According to the application requirements, parameters and recipe information are set for the independent operating equipment that can be operated by the intelligent distributed controller 6.

Specifically, the intelligent distributed controller 6 is controlled as both the control unit of the local mechanism and the distributed IO node of the main controller.

Specifically, the intelligent distributed controller 6 is installed with independent logic control program and can operate independently. The setting of operation parameters is given by the main control system.

The field of plastic particle raw material processing generally includes the main processes of drying, conveying, and mixing raw materials. The drying system usually includes equipment units such as drying air generators and drying bins. The conveying system usually includes a suction device, a vacuum pump, and a filter and other equipment. The mixing system is usually a single-machine mixer, either volumetric or weight.

FIG. 1 now shows a very schematic presentation of an embodiment of a structure of a plastic particle processing system according to the invention. The system includes per se known equipment units 2 to 5, such as a drying air generator mechanism 2, a number of drying bin mechanism 3, a secondary conveying mechanism 4 and a number of mixer or blender mechanisms 5. The blender mechanism 5 is positioned at injection moulding mechanism IMM (not shown). The equipment units 2, 3 and 5 are functionally arranged preferably one behind the other in a row according to the processing sequence of the plastic granulate. The secondary conveying mechanism 4 runs through the entire production process of plastic products of the plastic particle processing system performed by the equipment units 2, 3 and 5.

The dry air generator mechanism 2 includes modules 12 to 14 arranged in parallel, namely a dry air module 12, a booster module 13 and a low dewpoint module 14.

The dry air module 12 has two drying air modules 21 arranged in parallel and two intelligent distributed controllers 6. A controller 6 is assigned to each drying air module 21. For this purpose, each drying air module 21 is coupled to the controller 6 via a bidirectional data line Y. The dry air module 12 thus consists of two pairs of coupled drying air modules 21 and controller 6.

The booster module 13 comprises an air volume increase module 22 associated with an intelligent distributed controller 6 coupled to it via a bidirectional data line Y.

Low dewpoint module 14 also includes a low dewpoint module 23 associated with an intelligent distributed controller 6 that is coupled to it via a bidirectional data line Y.

The drying bin mechanism 3 comprises a preliminary or primary conveying and includes a drying bin unit 31 and a blender 32. The drying bin unit 31 has a drying bin 311, a loader 312 positioned on the bin 311 and a purging valve 313 at the underside of the bin 311. The components 311, 312, 313 are associated with an intelligent distributed controller 6 coupled to them via a bidirectional data line Y. The blender 32 comprises a dosing motor 11, which is coupled to a motor drive 9 via a bidirectional data line Y. Furthermore, the intelligent distributed controller 6 of the drying bin unit 31 and the motor drive 9 of the blender 32 are coupled to each other via a bidirectional data line Y, so that the drying bin unit 31 and the blender 32 of the drying bin mechanism 3 have a data connection to each other.

Therefore, the intelligent distributed controller 6 of drying bin unit 31 can simultaneously control the drying bin unit 31 and the blender 32 of the drying bin mechanism 3.

There can be one more further drying bin mechanism 3 constructed and equipped in the same way as described above and arranged in parallel.

The secondary conveying mechanism 4 is composed of a loader control 15, a purging valve control 16 and a filter and blower control 17, which are each arranged in parallel next to each other. The loader control 15 controls loaders 41 arranged on the top of an IMM (not shown). The purging valve control 16 controls purging valves 42 and the filter & blower control 17 controls vacuum pumps 43 and filters 44. Each of the units 41, 42, 43, 44 is coupled to a distributed node 7 via a bidirectional data line Y. The input and output signals of related units 15, 16, 17 are controlled by distributed nodes 7.

Blender mechanism 5 has an IO device 10 to which an intelligent distributed controller 6 is assigned. IO device 10 is coupled with it via a bidirectional data line Y. Blender mechanism 5 also comprises a dosing motor 11, which is coupled to a motor drive 9 via a bidirectional data line Y. In addition, the intelligent distributed controller 6 and the motor drive 9 are coupled to each other via a bidirectional data line Y.

There can be one more further blender mechanisms 5 constructed and equipped in the same way as described above and arranged in parallel.

With the intelligent distributed controllers 6, each equipment unit 2, 3 and 5 has its own independent control system. Secondary conveying mechanism 4 has the distributed nodes 7 instead. Each intelligent distributed controller 6 and each distributed node 7 is connected via a bidirectional data line Z with a main control 1, together featuring a communication network, specifically an Ethernet 8. Ethernet 8 thus specifies software and hardware to enable data exchange between the equipment units 2 to 5 connected in the Ethernet 8. Multiple protocols are available for connection via Ethernet 8, such as TPC, UDP, S7, PROFINET, MODBUS TCP and others. The electrical signals from the equipment units 2, 3, 4, 5 can be connected via Single Pair Ethernet (SPE) and other industry connecters based on ethernet technology.

The main control 1 is a computer unit containing suitable software to serve as the master controller of the plastic particle processing system. All intelligent distributed controllers 6, all distributed nodes 7 and the main control 1 are connected to the same network through Ethernet 8 and have assigned IP addresses and device names. The number, specification and model of the drying air generator mechanism 2, the drying bin mechanism 3 and the blender mechanism 5 are set in the main control 1. Intelligent distributed controller 6 are all installed with independent logic control program and can run independently. Parameters and recipe information are set for the independent operating equipment units 2, 3, 5 that can be operated by the intelligent distributed controller 6. The main control 1 performs unified management and control as master controller. The setting of the operating parameter is given by the main control 1.

Therefore, intelligent distributed controller 6 of dry air module 12, of booster module 13 and of low dewpoint module 14 of the dry air generator mechanism 2 each are connected with Ethernet 8. Drying bin mechanism 3 and blender mechanism 5 each are connected with Ethernet 8 via intelligent distributed controller 6, which controls the motor drive 9 and IO device 10 respectively.

Secondary conveying mechanism 4 having distributed the nodes 7. The related equipment, i.e. loader control 15, purging valve control 16 and filter and blower control 17, each are connected with Ethernet 8 via distributed nodes 7. Distributed nodes 7 are directly controlled by the main control 1.

The controller 6 of the drying bin unit 31 indirectly controls the control of the primary conveying part enclosed in drying bin mechanism 3, so that the drying bin unit 31 clearly knows the operation of the suction device or the loader 312. This is convenient for calculating the amount of material used, and the drying conditions can be adjusted in real time, so as to meet the drying effect. In addition, the number of signal cables laying and installation person-hours for the transmission of related equipment can also be greatly reduced, saving investment costs.

Furthermore, the controller 6 of the drying bin mechanism 3 can also be used as the distributed node 7 of the primary conveying of the drying bin mechanism 3. Equipment signals of the primary dosing part, such as the signals of the suction device or the loader 312 on the drying bin 311 and the cleaning or purging valve 313 under the drying bin 311, can be directly connected to the controller 6 of the drying bin 3. The primary conveying system indirectly controls the conveying equipment of the drying bin mechanism 3 through its controller 6.

The inventive system manages the information of all mixers or blenders 5, 32 and automatically links with other related equipment. For example, when the formula of the blender 32 changes, the drying parameters of the drying bin unit 31 can be automatically adjusted, and the suction or the loader 312 of the blender 32 can also be automatically adjusted. The material source reduces the workload of daily operations and greatly reduces the error rate of operations, thereby improving the production efficiency of the factory.

The principle of the invention is to provide a plastic particle processing system structure based on Ethernet communication that can coordinate and link each link of the raw material processing system. Every individual equipment unit 2, 3, 4, 5 like drying, conveying and dosing and mixing has its own intelligence through controller 6 or distributed node 7 to control itself. All detection and execution components in the units 2, 3, 5 are connected to their own controller 6.

Main control 1 as a master controller take the decision based on the production conditions and the individual controllers performance of controllers 6 and nodes 7, to produce new setpoints to the individual drying, conveying and dosing and mixing control systems. Main control 1 manages and controls the drying, conveying and dosing and mixing systems in line with the production changes. It acts as a supervisor with its artificial intelligence and control logics to coordinate the best possible parameters to run the production in an optimized way to save material and energy. Even without the main control 1, the system can work on its own to run the production since it has its own local intelligence. With the invention the unified management of each independent process equipment or equipment unit can be achieved, it will greatly affect the efficiency of plant operation in a positive way. Due to the use of known Ethernet standards system deployment and structure, expansion can be completed easily.

### Embodiment 1

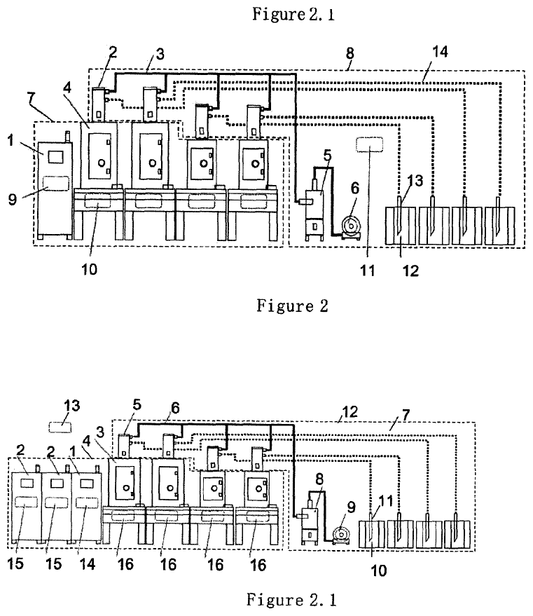

As shown in FIG. 2, the material supply of the drying system is completed by the conveying system. The material consumption of the drying bin is calculated by the volume and the frequency of the suction of the material supplied to it. The actual material consumption of the drying bin is closely related to the drying control of the drying bin. There is usually only one feeding suction of the drying bin, while there are usually more than one material outlet. Then the material consumption of the drying bin needs to be calculated according to the volume and frequency of the feeding hopper loader. The drying bin needs to adjust the drying air volume and drying temperature according to the different material consumption, which is very important for improving the drying efficiency and saving energy consumption.

The drying system 7 has the dry air generator 1 and four drying bins 4. The dry air generator 1 has the main control 9. The drying bins 4 are provided with the distributed I/O-nodes 10.

Positioned on each drying bin 4 is a hopper loader 2. The material to be conveyed is stored in material bins 12 connected via pipes 14 to the hopper loaders 2 in an usual manner.

Each hopper loader is further connected via vacuum pipes 3 with a vacuum pump 6. In the line between the vacuum pump 6 and the hopper loaders 6 there is at least one filtering device 5.

The hopper loaders 6, the fittings device 5, the vacuum pump 6, the material bins 12 and the pipes 3, 14 are part of the conveying system 8. It has the main control 11.

Each material bin 12 is provided with a suction probe 13 to which is connected the corresponding material pipe 14.

FIG. 2.1 shows an optimized existing situation. The drying system 4 includes two dry air modules 2, each containing an intelligent distributed control of dry air modules 15, and a booster module 1 containing an intelligent distributed control of booster module 14 and four drying bins 3, each comprising an intelligent distributed control of drying bin 16. The conveying system 12 (comprised by the drying bin mechanism according to FIG. 1) includes four hopper loaders 5, vacuum pipes 6, communicating with a vacuum pump 9 and a filtering device 8, and material pipes 7, suction probes 11 and material bins 10.

The conveying system 12 is controlled by main controller 13 directly. The drying system 4 and the main controller 13 are communicating with each other via ethernet (not shown), so the drying bin 3 knows the operation of the feeding hopper loader 5, it adjusts air flow requirement according to the data from conveying system 12. The energy consumption can be reduced. The conveying system 12 is controlling the material conveying of the whole workshop, even the main controller 13 is not very close to the drying system 4. But the control of the hopper loader 5 installed on the drying bin 3 and the control (6) of the purging valve (313) installed on the bottom of the drying bin 3 can be connected to drying bin 3 directly, they can be controlled by main controller 13 indirectly via drying bin control 16. The installation and maintenance costs can be reduced.

The embodiment according to FIG. 2.1 otherwise corresponds to the previous embodiment.

### Embodiment 2

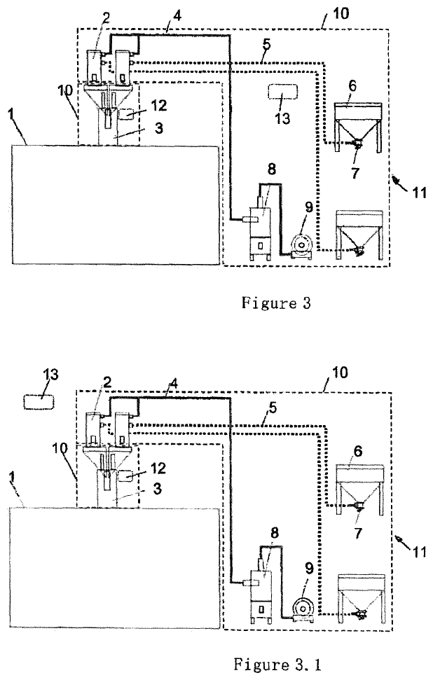

As shown in FIG. 3, an injection moulding machine (IMM) 1 is connected with a dosing and mixing system 10, supplied from a conveying system 11. The dosing and mixing system 10 comprises a gravimetric blender 3 and a control of dosing and mixing system 12. The material supply of the blender 3 is completed by the conveying system 11. The conveying system 11 comprises a hopper loader 2, vacuum pipes 4 connected to a filter 8 and a vacuum pump 9 and two material pipes 5 connected to two material storage bins 6, each with a purging valve 7, and a control of the conveying system 13.

The blender 3 often needs to switch the material recipe, and the materials used also need to change automatically. This requires changing the material source setting of the suction in the conveying system 11.

FIG. 3.1 shows an optimized existing situation. Instead of control 13 of the (secondary) conveying system 11 there is a main control 13 controlling the whole system. Other differences of FIG. 3 compared to FIG. 3.1 are not recognizable. When the blender 3 needs to switch the recipe, the operator switches the recipe in the blender 3, and it is unnecessary to modify the material of the hopper loader 2 in conveying system 11. The main controller 13 will get the change of recipe from blender 3, to change the material number of the loader 2 which is installed on the blender 3 (5) according to the recipe requirements. It is convenient to operate and also reduces the risk of selecting the wrong material.

### Embodiment 3

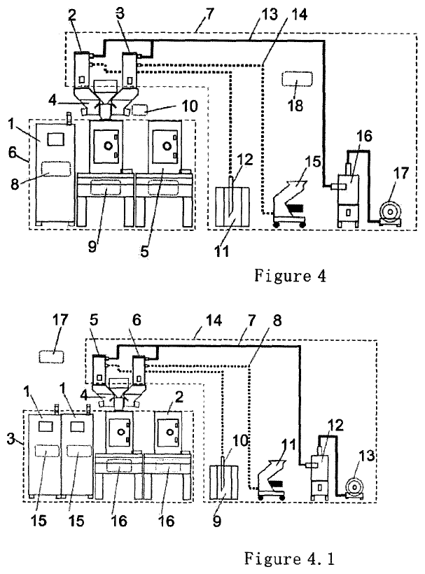

As shown in FIG. 4, when regrind materials are produced from the injection molding process, it is necessary to recycle the regrind materials and mix them with new raw materials in a certain proportion before drying. Usually, the factory will install the blender 4 on the drying bin 5, set a certain proportion in the blender 4, and put the mixed materials into the drying bin 5.

FIG. 4.1 shows an optimized existing situation. The shown drying system 3 comprises two dry air modules 1, each controlled by an intelligent distributed control of dry air module 15, and two drying bins 2 controlled by an intelligent distributed control of drying bin and blender 16. The conveying system 14 comprises two hopper loaders 5, 6, namely a hopper loader 5 for virgin material and a hopper loader 6 for regrind material, a vacuum pipe 7 connected to a vacuum pump 13 and a filter 12. The hopper loader 5 is connected to a material bin 9 and a suction probe 10 via a material pipe 8. The hopper loader 6 is connected to a grinder 11 via a material pipe 8. Between the loader 5, 6 and the two drying bins 2 there is a volumetric blender 4. Instead of the two controls 10, 18 according to FIG. 4 there is a main control 17 controlling the whole system.

The drying bin controller 16 is integrated with multiple functions of drying bin 2 and blender 4. Different material proportions (different recipes) have different requirements for the feeding process. When the blender 4 needs to switch the recipe, the drying information of the drying bin 2 in the drying system 3 will be automatically modified according to the recipe requirements after switching the recipe in the blender 4, such as drying temperature and drying time. It is convenient for operation and reduce the risk of wrong settings. It will greatly improve the efficiency of plant operation.

Each embodiment in this specification is described in a progressive manner. The same and similar parts between each embodiment can be seen from each other. Each embodiment focuses on the differences from other embodiments. In particular, for the system embodiment, because it is basically similar to the method embodiment, the description is relatively simple. Please refer to the partial description of the method embodiment for details.

The above is only an embodiment of the invention and is not intended to limit the invention. For those skilled in the art, the invention can have various changes. Any modification, equivalent replacement, improvement, etc. made within the spirit and principle of the invention shall be included in the scope of the claims of the invention.

1.-9. (canceled)

10. A plastic particle processing system structure, comprising:
a main controller (1);
a drying air generator mechanism (2);
a drying bin mechanism (3);
a conveying mechanism (4); and
a blender mechanism (5),
wherein the drying air generator mechanism (2), the drying bin mechanism (3), the conveying mechanism, and the blender mechanism (5) are connected to the main controller (1) through an Ethernet network (8),
wherein components of the drying air generator mechanism (2), the drying bin mechanism (3), the conveying mechanism, and the blender mechanism (5) are installed with intelligent distributed controllers (6) and with distributed nodes (7), and
wherein the intelligent distributed controllers (6) and the distributed nodes (7) are connected to the Ethernet network (8), and
wherein IP addresses and device names are assigned.

11. The plastic particle processing system structure according to claim 10,
wherein a number, a specification and a model of the drying air generator mechanism (2), the drying bin mechanism (3), and the blender mechanism (5) are set in the main controller (1), and
wherein parameters and recipe information are set for independent operating equipment that can be operated by the intelligent distributed controllers (6) according to application requirements.

12. The plastic particle processing system structure according to claim 10,
wherein the intelligent distributed controllers (6) can not only act as a control unit of a local mechanism, but also have a distributed IO node (10) as the main controller (1) under control.

13. The plastic particle processing system structure according to claim 10,
wherein the intelligent distributed controllers (6) are installed with independent logic control programs and can operate independently, and
wherein setting of operation parameters is given by the main controller (1).

14. The plastic particle processing system structure according to claim 10,
wherein the drying air generator mechanism (2) comprises at least one drying air module (12), at least one air volume amplification module (13), and at least one low dewpoint module (14).

15. The plastic particle processing system structure according to claim 10,
wherein the drying bin mechanism (3) comprises at least one drying bin unit (31) and at least one blender (32), and
wherein the at least one drying bin unit (31) comprises a drying bin (311), a hopper loader (312), and a purging valve (312).

16. The plastic particle processing system structure according to claim 10,
wherein the conveying mechanism (4) comprises at least one hopper loader (41), at least one purging valve (42), at least one vacuum pump (6, 9), and at least one filter (5, 8).

17. The plastic particle processing system structure according to claim 10,
wherein the drying air generator mechanism (2) and the drying bin mechanism (3) are installed with the intelligent distributed controllers (6).

18. The plastic particle processing system structure according to claim 10,
wherein the conveying mechanism (4) is installed with the distributed nodes (7).
